(19) United States
(12) Patent Application Publication
(10) Pub. No.: US 2006/0125887 A1
(43) Pub. Date: Jun. 15, 2006

(54) Fluid reservoir and ink pen assembly

(76) Inventor: Peter G. Hwang, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/013,600

(22) Filed: Dec. 15, 2004

(51) Int. Cl. B41J 2/175

(52) U.S. Cl. 347/86

(57) ABSTRACT

In one embodiment, a reservoir for holding a fluid includes a housing defining an enclosed tank having a first corner between first walls that intersect at an angle less than 90° and a second corner between second walls that intersect at an angle less than 90°. The second corner is located opposite the first corner across the tank. A first opening in the housing is located at or near the first corner of the tank and a second opening in the housing is located at or near the second corner of the tank.

### BACKGROUND

Some inkjet printing systems utilize replaceable ink supply cartridges positioned or carried adjacent to the ink pens to supply and resupply the pens with ink. Ink supply cartridges are vented to allow ink to flow from the cartridge into the ink pen. Vertical printers, in which the print media input and output trays are oriented vertically, are emerging as one of the latest innovations in minimizing desktop printer space. Conventional ink supply cartridges designed for use in horizontal printers do not work when rotated up for use in a vertical printer because the vent is submerged in ink.

### DRAWINGS

FIG. 1 illustrates a horizontal printer.

FIG. 2 illustrates a vertical printer.

FIG. 3 is a perspective view of an ink pen assembly that includes a multiple color ink pen with attached yellow, magenta and cyan ink supply cartridges.

FIG. 4 is a perspective view of an ink pen assembly that includes a single color ink pen with an attached black supply cartridge.

FIGS. 5 and 6 are partial section views of an ink pen assembly, such as the ones shown in FIGS. 3 and 4, in horizontal and vertical orientations, respectively.

FIGS. 7 and 8 illustrate the ink pen assemblies of FIGS. 5 and 6 with the ink supply cartridge detached from the ink pen.

FIGS. 9 and 10 are section views of an ink supply cartridge in horizontal and vertical orientations, respectively.

FIG. 11 is a section view illustrating a portion of a printhead for a multiple color ink pen such as the one shown in FIG. 3.

FIG. 12 is a section view of an ink supply cartridge with a drain well.

FIG. 13 is a section view of an ink supply cartridge with curvilinear walls.

### DESCRIPTION

Embodiments of the present invention were developed in an effort to provide an ink supply cartridge for use in both horizontal printers and vertical printers. Some embodiments of the invention, therefore, will be described with reference to inkjet printing and ink pens. An ink pen is also commonly referred to as an ink cartridge, a print cartridge or an inkjet print head assembly. Embodiments of the invention, however, are not limited to use in inkjet printing, ink pens or with ink. Rather, embodiments of the invention may be used in any application or environment which might benefit from the configuration of the fluid reservoir used in the new ink supply cartridges. The exemplary embodiments shown in the figures and described below illustrate but do not limit the invention. Other forms, details, and embodiments may be made and implemented. Hence, the following description should not be construed to limit the scope of the invention, which is defined in the claims that follow the description.

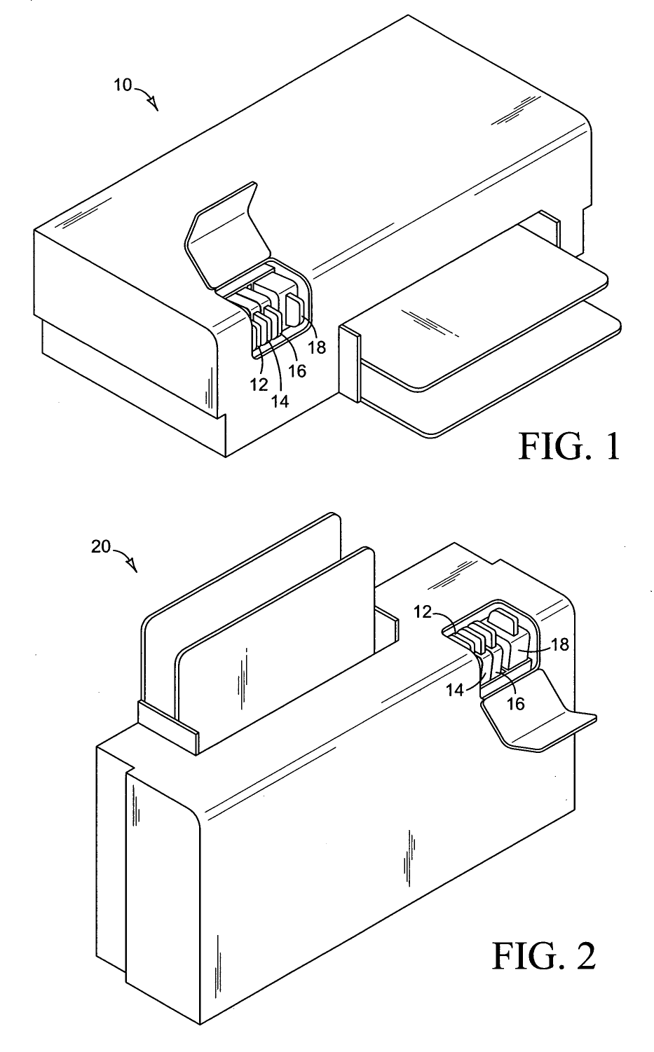

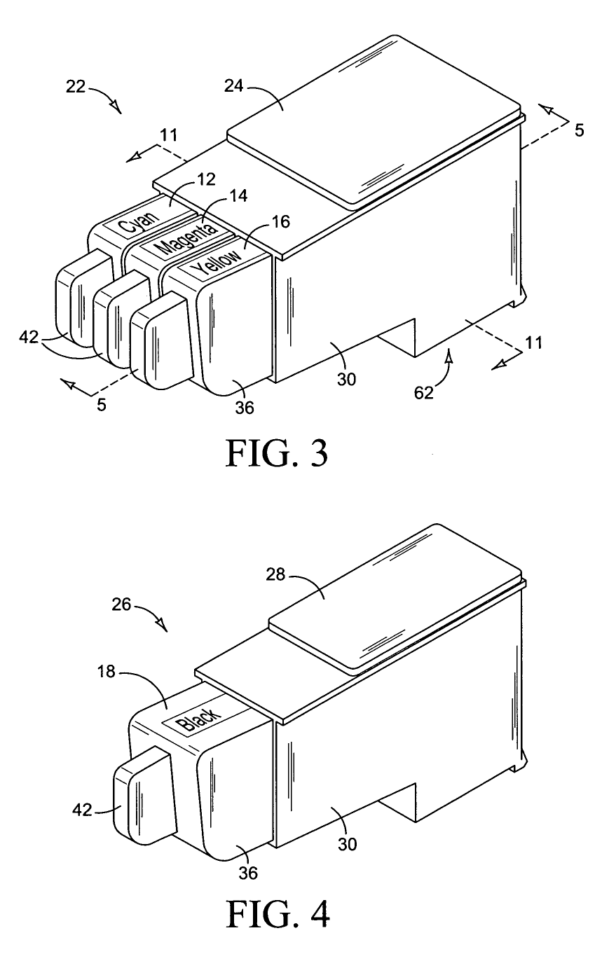

FIG. 1 illustrates a horizontal printer 10 in which color ink supply cartridges 12, 14 and 16 attached to a multiple color ink pen (shown in FIG. 3) and a black ink supply cartridge 18 attached to a single color ink pen (shown in FIG. 4) are oriented horizontally. FIG. 2 illustrates a vertical printer 20 in which the ink supply cartridges 12-18 and attached ink pens are oriented vertically. FIG. 3 shows a multiple color ink pen assembly 22 that includes a multiple color ink pen 24 and ink supply cartridges 12, 14 and 16 attached to ink pen 24. Cyan, magenta and yellow cartridges 12, 14 and 16 are shown in FIGS. 1-3 as one example of the colors commonly used with multiple color ink pen 24 and printers 10 and 20. FIG. 4 shows a single color ink pen assembly 26 that includes a single color ink pen 28 and black ink supply cartridge 18 attached to ink pen 28. Black cartridge 18 is shown in FIGS. 1, 2 and 4 as one example of a color commonly used in single color ink pen 28.

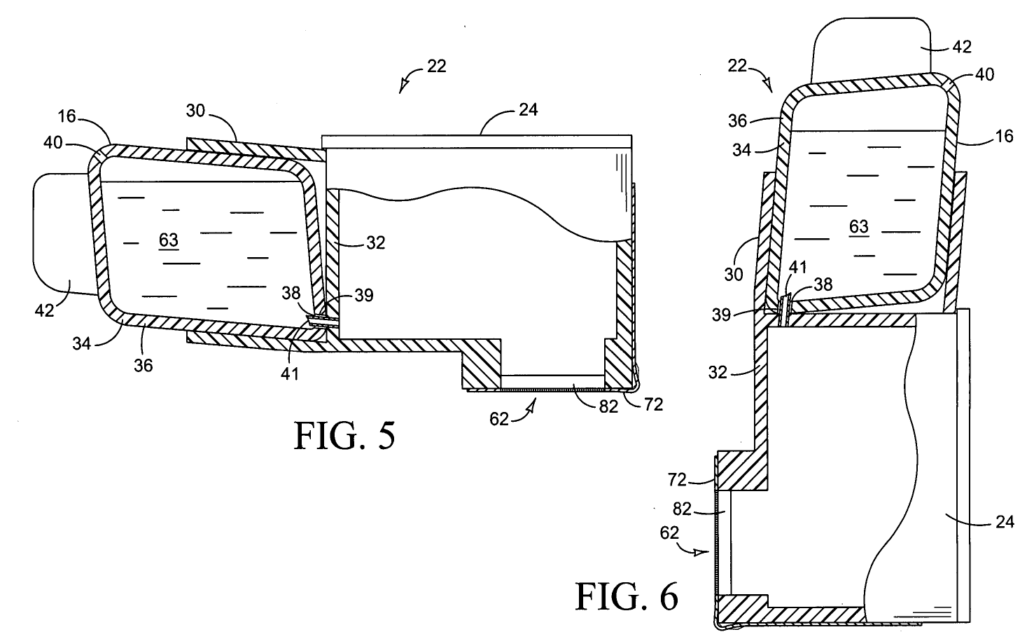

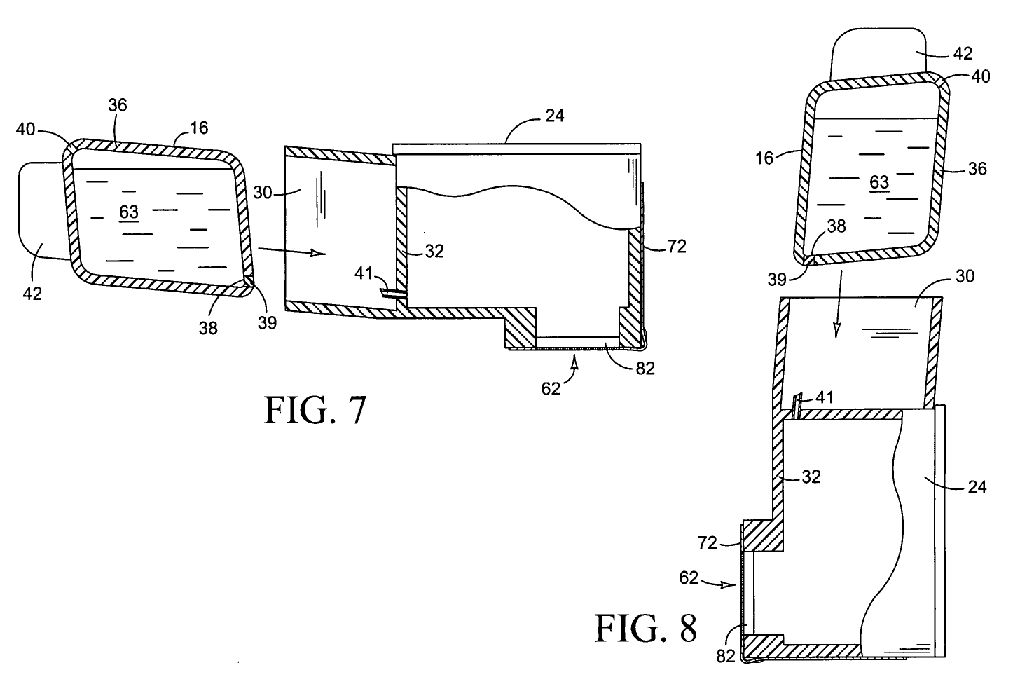

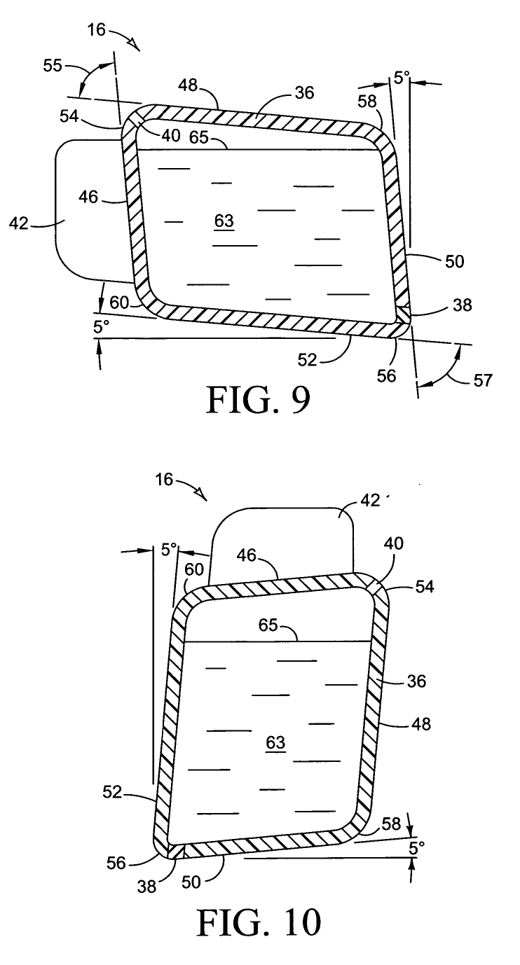

FIGS. 5 and 6 are side elevation and partial section views of an ink pen assembly 22 or 26. FIG. 5 shows the ink pen assembly in a horizontal orientation. FIG. 6 shows the ink pen assembly in a vertical orientation. FIGS. 7 and 8 are similar to FIGS. 5 and 6 except that the supply cartridge is detached from the ink pen. FIGS. 9 and 10 show the ink supply cartridge alone in each orientation. For convenience, the ink pen assembly shown in FIGS. 5-8 will be identified as the multiple color ink pen assembly 22 with the section taken along a line 5-5 in FIG. 3 through the yellow supply cartridge 16, although the description of FIGS. 5-8 also applies to assembly 26 and the other supply cartridges 12, 14 and 18.

Referring to FIGS. 5-8, supply cartridge 16 fits into a receiver 30 extending from a housing 32 of ink pen 24. Cartridge 16 includes a housing 34 that encloses an ink storage tank 36, an outlet 38 and a vent 40. A flat flange 42 extends to the rear of housing 34 to make it easier for a user to grasp cartridge 16 for installation and removal. Although supply cartridge housing 34 is shown as a seamless unit, housing 34 may be formed as discrete body and lid parts affixed to one another. In some printing environments, such as the one shown in FIGS. 1-4, vent 40 will be exposed directly to the atmosphere. In other printing environments for supply cartridge 16, however, vent 40 may be exposed to the return side of an ink delivery system and allow pumping, remote venting, bleeding or pressurization as well as recirculation. Hence, direct venting to the atmosphere is just one example for vent 40. Also, vent 40 may be exposed to the atmosphere through a circuitous tunnel (not shown), commonly referred to as a labyrinth, formed by a recess in the top of cartridge housing 34 covered by a label or other suitable cover. Labyrinths, which are well known in the art of inkjet printing, are commonly used for venting ink pens to slow the rate of evaporation. In the embodiment shown in FIGS. 5-8, outlet 38 is sealed with an elastic membrane 39. When supply cartridge 16 is installed in receiver 30, a needle 41 projecting from ink pen housing 32 pierces membrane 39 to provide a pathway for ink to flow from supply cartridge 16 to ink pen 24.

Referring now also to FIGS. 9 and 10, the walls 46, 48, 50 and 52 that define the shape of tank 36 form a parallelogram, except with rounded corners 54, 56, 58 and 60. Vent 40 is positioned at first corner 54 of tank 36 and outlet 38 is positioned at second corner 56 diagonally across from first corner 54. First and second walls 46 and 48 intersect at first corner 54 at an included angle 55 of less than 900. Third and fourth walls 50 and 52 intersect at second corner 56 at an included angle 57 less than 90° . In this configuration, second wall 48 slopes up toward vent 40 and fourth wall 52 opposite second wall 48 slopes down toward outlet 38 when cartridge 16 is oriented horizontally, as shown in FIGS. 5, 7 and 9, and first wall 46 slopes up toward vent 40 and third wall 50 opposite first wall 46 slopes down toward outlet 38 when cartridge 16 is oriented vertically, as shown in FIGS. 6, 8 and 10. As a result, vent 40 stays at or near the upper extreme of tank 36 above the high water mark 65 of ink 63 in both orientations and outlet 38 remains at or near the lower extreme of tank 36 in both orientations.

As used in this document, “corner” means the space between two converging lines or surfaces at or near their intersection or, if the lines or surfaces don't physically meet one another, the space between the two converging lines or surfaces near their intersection if extended out to physically meet one another. This meaning covers, for example, squared corners, rounded corners, faceted corners, and the like. As used in this document, walls that intersect means walls that meet at a point or along a line or, if the walls don't physically meet one another, walls that would meet at a point or along a line if extended out to physically meet one another.

In the embodiment of cartridge 16 shown in FIGS. 9 and 10, in which tank 36 is parallelogram shaped, the included angle at opposing corners 54 and 56 is the same. For this configuration, it is expected that an included angle in the range of 70°-84° distributed evenly along each intersecting wall will provide adequate drainage to outlet 38 and adequate clearance to vent 40 for most inkjet printing applications. For example, as shown in FIGS. 9 and 10, an included angle 57 of 80° at second corner 56 is distributed evenly along intersecting walls 50 and 52 by locating each wall 5° in from the vertical and horizontal reference planes. Other configurations are possible. The shape of tank 36, the angles at which the walls intersect and the distribution of these angles to the intersecting walls may be varied from those shown to suit any particular application. In certain implementations, for example, tank 36 may have a different quadrangular shape or other polygonal shape.

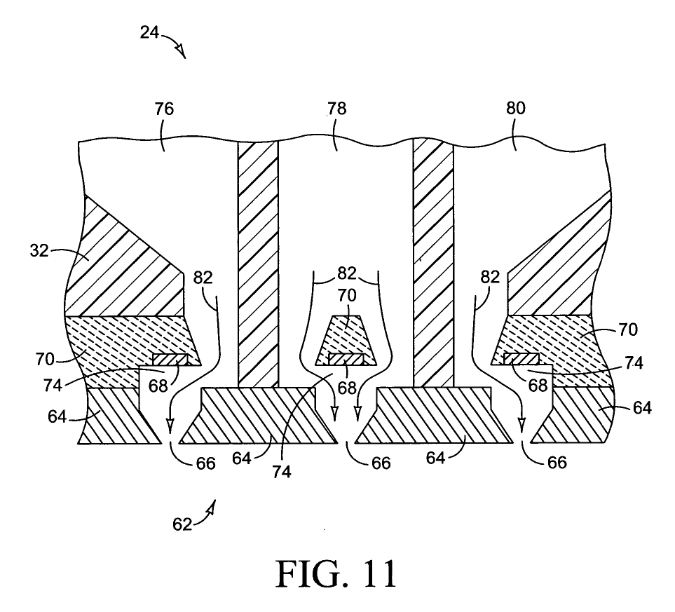

FIG. 11 is a partial front elevation section view taken along the line 11-11 in FIG. 3 showing the ink ejection nozzle area of ink pen 24. Referring to FIGS. 5-8 and 11, a print head 62 is located at the bottom of ink pen 24. Print head 62 includes an orifice plate 64 with ink ejection orifices 66 and firing resistors 68 formed on an integrated circuit chip 70 positioned behind ink ejection orifices 66. A flexible circuit 72 carries electrical traces from external contact pads (not shown) to firing resistors 68. When ink pen 24 is installed in a printer, pen 24 is electrically connected to the printer controller through the contact pads. In operation, the printer controller selectively energizes firing resistors 68 through the signal traces in flexible circuit 72. When a firing resistor 68 is energized, ink in a vaporization chamber 74 next to a resistor 68 is vaporized, ejecting a droplet of ink through orifice 66 on to the print media. Vaporization chamber 74 then refills with ink from ink reservoirs 76, 78 or 80 in preparation for the next ejection. The flow of ink through print head 62 is illustrated by arrows 82 in FIG. 11. Each ink reservoir 76, 78 and 80 can be supplied and resupplied with ink from the respective supply cartridges 12, 14 and 16 through needle 41 at an inlet port 82 in each reservoir 76, 78 and 80.

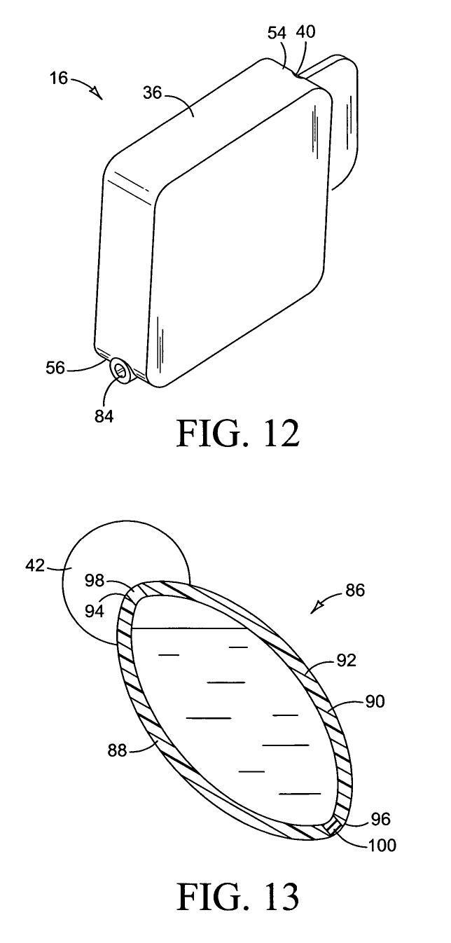

In the embodiment of cartridge 16 shown in FIG. 12, a drain well 84 is formed at corner 56 to help ensure that as much as ink as possible may be drained from tank 36. In the embodiment of an ink cartridge 86 shown in FIG. 13, curvilinear walls 88 and 90 define an oval shaped tank 92. Walls 88 and 90 intersect at corners 94 and 96 at an included angle less than 90°. A vent 98 is located at the upper corner 94 of tank 92 and a drain is located at the lower corner 96.

As noted at the beginning of this Description, the exemplary embodiments shown in the figures and described above illustrate but do not limit the invention. Other forms, details, and embodiments may be made and implemented. Therefore, the foregoing description should not be construed to limit the scope of the invention, which is defined in the following claims.

What is claimed is:

1. A reservoir for holding a fluid, comprising a housing defining an enclosed tank having a first corner between first walls that intersect at an angle less than 90° and a second corner between second walls that intersect at an angle less than 90°, the second corner located opposite the first corner across the tank, and the housing having a first opening therein at or near the first corner of the tank and a second opening therein at or near the second corner of the tank.

2. The reservoir of claim 1, wherein the first walls and the second walls comprise rectilinear walls.

3. The reservoir of claim 1, wherein the first walls intersect at an angle in the range of 70°-84°.

4. The reservoir of claim 1, wherein the first walls intersect at an angle in the range of 70°-84° and the second walls intersect at an angle in the range of 70°-84°.

5. A reservoir for holding a fluid, comprising a housing defining an enclosed tank having a first corner between first and second walls that intersect at an angle less than 90° and a second corner between the first and second walls that intersect at an angle less than 90°, the second corner located opposite the first corner across the tank, and the housing having a first opening therein at or near the first corner of the tank and a second opening therein at or near the second corner of the tank.

6. The reservoir of claim 5, wherein the first walls and the second walls comprise curvilinear walls.

7. A reservoir for holding a fluid, comprising an enclosed tank having a vent and an outlet, the tank characterized by:
a first wall that slopes up toward the vent when the tank is in a first orientation and a second wall opposite the first wall that slopes down toward the outlet when the tank is in the first orientation; and
a third wall that slopes up toward the vent when the tank is in a second orientation rotated 90° from the first orientation and a fourth wall opposite the third wall that slopes down toward the outlet when the tank is in the second orientation.

8. The reservoir of claim 7, wherein the first and second walls comprise rectilinear walls that slope at an angle in the range of 3°-10° relative to horizontal when the tank is in the first orientation and the third and fourth walls comprise rectilinear walls that slope at an angle in the range of 3°-10° relative to horizontal when the tank is in the second orientation.

9. A reservoir for holding a fluid, comprising an enclosed tank having a vent and an outlet, the tank characterized by:
a first curvilinear wall that slopes up toward the vent when the tank is in a first orientation and down toward the outlet when the tank is in a second orientation rotated 90° from the first orientation; and
a second curvilinear wall that slopes down toward the outlet when the tank is in the first orientation and up toward the vent when the tank is in the second orientation.

10. An ink pen assembly, comprising:
an ink pen having an ink reservoir and a print head operatively connected to the ink reservoir; and
a supply cartridge removably connected to the ink pen so that ink may flow from the supply cartridge to the ink reservoir, the supply cartridge comprising
a housing defining an enclosed tank having a first corner between first walls that intersect at an angle less than 90° and a second corner between second walls that intersect at an angle less than 90°, the second corner located opposite the first corner across the tank, and the housing having a first opening therein at or near the first corner of the tank and a second opening therein at or near the second corner of the tank.

11. The assembly of claim 10, wherein the first walls and the second walls comprise rectilinear walls.

12. An ink pen assembly, comprising:
an ink pen having an ink reservoir and a print head operatively connected to the ink reservoir; and
a supply cartridge removably connected to the ink pen so that ink may flow from the supply cartridge to the ink reservoir, the supply cartridge comprising
a housing defining an enclosed tank having a first corner between first and second walls that intersect at an angle less than 90° and a second corner between the first and second walls that intersect at an angle less than 90°, the second corner located opposite the first corner across the tank, and the housing having a first opening therein at or near the first corner of the tank and a second opening therein at or near the second corner of the tank.

13. The assembly of claim 12, wherein the first walls and the second walls comprise curvilinear walls.

14. An ink pen assembly, comprising:
an ink pen having an ink reservoir and a print head operatively connected to the ink reservoir; and
a supply cartridge removably connected to the ink pen so that ink may flow from the supply cartridge to the ink reservoir, the supply cartridge comprising an enclosed tank having a vent and an outlet, the tank characterized by:
a first wall that slopes up toward the vent when the tank is in a first orientation and a second wall opposite the first wall that slopes down toward the outlet when the tank is in the first orientation; and
a third wall that slopes up toward the vent when the tank is in a second orientation rotated 90° from the first orientation and a fourth wall opposite the third wall that slopes down toward the outlet when the tank is in the second orientation.

15. The assembly of claim 14, wherein the first and second walls comprise rectilinear walls that slope at an angle in the range of 3°-10° relative to horizontal when the tank is in the first orientation and the third and fourth walls comprise rectilinear walls that slope at an angle in the range of 3°-10° relative to horizontal when the tank is in the second orientation.

16. An ink pen assembly, comprising:
an ink pen having an ink reservoir and a print head operatively connected to the ink reservoir; and
a supply cartridge removably connected to the ink pen so that ink may flow from the supply cartridge to the ink reservoir, the supply cartridge comprising an enclosed tank having a vent and an outlet, the tank characterized by:
a first curvilinear wall that slopes up toward the vent when the tank is in a first orientation and down toward the outlet when the tank is in a second orientation rotated 90° from the first orientation; and
a second curvilinear wall that slopes down toward the outlet when the tank is in the first orientation and up toward the vent when the tank is in the second orientation.

17. A reservoir for holding a fluid, comprising an enclosed tank having a vent and an outlet, the tank characterized by a means for positioning the vent at an upper extreme of the tank when the tank is in a first orientation and when the tank is in a second orientation rotated 90° from the first orientation and for positioning the outlet at a lower extreme of the tank when the tank is in the first orientation and when the tank is in the second orientation.

18. The reservoir of claim 17, where the positioning means comprises a first wall that slopes up toward the vent when the tank is in the first orientation, a second wall opposite the first wall that slopes down toward the outlet when the tank is in the first orientation, a third wall that slopes up toward the vent when the tank is in the second orientation and a fourth wall opposite the third wall that slopes down toward the outlet when the tank is in the second orientation.

19. The reservoir of claim 17, where the positioning means comprises a first curvilinear wall that slopes up toward the vent when the tank is in the first orientation and down toward the outlet when the tank is in the second orientation and a second curvilinear wall that slopes down toward the outlet when the tank is in the first orientation and up toward the vent when the tank is in the second orientation.

20. A fluid reservoir for use in differently configured printing systems, the fluid reservoir comprising:
a housing forming a tank therein for holding fluid, the housing being shaped to provide a vent area and an outlet area within the tank, such that when the housing is positioned in an initial orientation the vent area is substantially a highest point within the tank and the outlet area is substantially a lowest point within the tank, and when the housing is rotated from the initial orientation to a different orientation the vent area is again substantially the highest point within the tank and the outlet area is again substantially the lowest point within the tank;
a vent opening extending through the housing in the vent area; and
a fluid outlet extending through the housing in the outlet area.

21. The fluid reservoir of claim 20, wherein the vent and outlet areas are at or near different corners of the tank as formed by the housing.

22. The fluid reservoir of claim 20, wherein the housing is rotated approximately ninety degrees from the initial orientation to the different orientation.

23. The fluid reservoir of claim 20, wherein the housing has at least one rectilinear wall forming a part of the tank.

24. The fluid reservoir of claim 20, wherein the housing has at least one curvilinear wall forming a part of the tank.

25. The fluid reservoir of claim 20, wherein the fluid outlet includes a drain well.

26. An ink pen assembly, comprising:
an ink pen having an ink reservoir and a print head operatively connected to the ink reservoir; and
a supply cartridge removably connected to the ink pen so that ink may flow from the supply cartridge to the ink reservoir, the supply cartridge comprising
a housing forming a tank therein for holding fluid, the housing being shaped to provide a vent area and an outlet area within the tank, such that when the housing is positioned in an initial orientation the vent area is substantially a highest point within the tank and the outlet area is substantially a lowest point within the tank, and when the housing is rotated from the initial orientation to a different orientation the vent area is again substantially the highest point within the tank and the outlet area is again substantially the lowest point within the tank,
a vent opening extending through the housing in the vent area, and
a fluid outlet extending through the housing in the outlet area.

27. The assembly of claim 26, wherein the vent and outlet areas are at or near different corners of the tank as formed by the housing.

28. The assembly of claim 26, wherein the housing is rotated approximately ninety degrees from the initial orientation to the different orientation.

29. The assembly of claim 26, wherein the housing has at least one rectilinear wall forming a part of the tank.

30. The assembly of claim 26, wherein the housing has at least one curvilinear wall forming a part of the tank.

31. The assembly of claim 26, wherein the fluid outlet includes a drain well.
